(19) United States
(12) Patent Application Publication
(10) Pub. No.: US 2014/0071619 A1
(43) Pub. Date: Mar. 13, 2014

(54) LOCKING APPARATUS FOR A PORTABLE ELECTRON DEVICE

(71) Applicant: JIN TAY INDUSTRIES CO., LTD., New Taipei City (TW)

(72) Inventor: Kuo-Tsung Yang, Taipei City (TW)

(73) Assignee: JIN TAY INDUSTRIES CO., LTD., NEW TAIPEI CITY (TW)

(21) Appl. No.: 13/680,034

(22) Filed: Nov. 17, 2012

(30) Foreign Application Priority Data
Sep. 12, 2012 (TW) 101133367

(51) Int. Cl. G06F 21/88

(52) U.S. Cl. CPC G06F 21/88
USPC 361/679.57

(57) ABSTRACT

A locking apparatus for a portable electron device has a main frame, a casing, an inserting element and a lock. The main frame has two clamping segments, a mounting segment and a limiting hole. The casing is mounted around the mounting segment and has a mounting opening and at least one operating opening. The inserting element is mounted movably in the casing and is screwed with and mounted through the limiting hole. The lock mounted securely on the casing and has a body, a controlling element and an extending element. The controlling element is mounted movably in the body, aligns with and selectively abuts the inserting element to limiting the movement of the inserting element. The extending element is securely connected to the body and has a mounting end.

### BACKGROUND OF THE INVENTION

1. Field of the Invention

The present invention relates to a locking apparatus, and more particularly to a locking apparatus for a portable electron device to lock the electron device at a specific position to prevent the portable electron device from being stolen when the portable electron device is not taken with a user.

2. Description of Related Art

With the evolution of technology, more and more portable electron devices such as mobile phones or tablet computers are produced and have multi-functions and a high price.

However, the portable electron devices can be taken with the user, the portable electron device has a certain volume and cannot be taken conveniently with the user when the user temporarily leaves. For example, when the user uses a tablet computer in a coffee shop or a library and wants to take meals or to toilet without tanking with the tablet computer conveniently. Then, the tablet computer may be stolen when the tablet computer is not taken with the user.

To overcome the shortcomings, the present invention provides a locking apparatus for a portable electron device to mitigate or obviate the aforementioned problems.

### SUMMARY OF THE INVENTION

The primary objective of the present invention is to provide a locking apparatus for a portable electron device to lock the electron device at a specific position to prevent the portable electron device from being stolen when the portable electron device is not taken with a user.

The locking apparatus for a portable electron device in accordance with the present invention has a main frame, a casing, an inserting element and a lock. The main frame has two clamping segments, a mounting segment and a limiting hole. The casing is mounted around the mounting segment and has a mounting opening and at least one operating opening. The inserting element is mounted movably in the casing and is screwed with and mounted through the limiting hole. The lock mounted securely on the casing and has a body, a controlling element and an extending element. The controlling element is mounted movably in the body, aligns with and selectively abuts the inserting element to limiting the movement of the inserting element. The extending element is securely connected to the body and has a mounting end.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a locking apparatus for a portable electron device in accordance with the present invention connecting with a portable electron device;

FIG. 2 is an enlarged and exploded perspective view of the locking apparatus for a portable electron device in FIG. 1;

FIG. 3 is an enlarged side view in partial section of the locking apparatus in FIG. 1 connecting with a portable electron device in a lock condition;

FIG. 4 is an enlarged side view in partial section of the locking apparatus in FIG. 1 connecting with a portable electron device in an unlock condition;

FIG. 5 is an enlarged operational side view in partial section of the locking apparatus in FIG. 1 connecting with a portable electron device in an unlock condition;

FIG. 6 is an operational perspective view of the locking apparatus in FIG. 1 being mounted between a post and a portable electron device;

FIG. 7 is a perspective view of a second embodiment of a locking apparatus for a portable electron device in accordance with the present invention;

FIG. 8 is an enlarged and exploded perspective view of the locking apparatus for a portable electron device in FIG. 7;

FIG. 9 is an enlarged side view in partial section of the locking apparatus in FIG. 7 connecting with a portable electron device; and

FIG. 10 is an operational perspective view of the locking apparatus in FIG. 7 being mounted between a post and a portable electron device.

### DETAILED DESCRIPTION OF THE PREFERRED EMBODIMENT

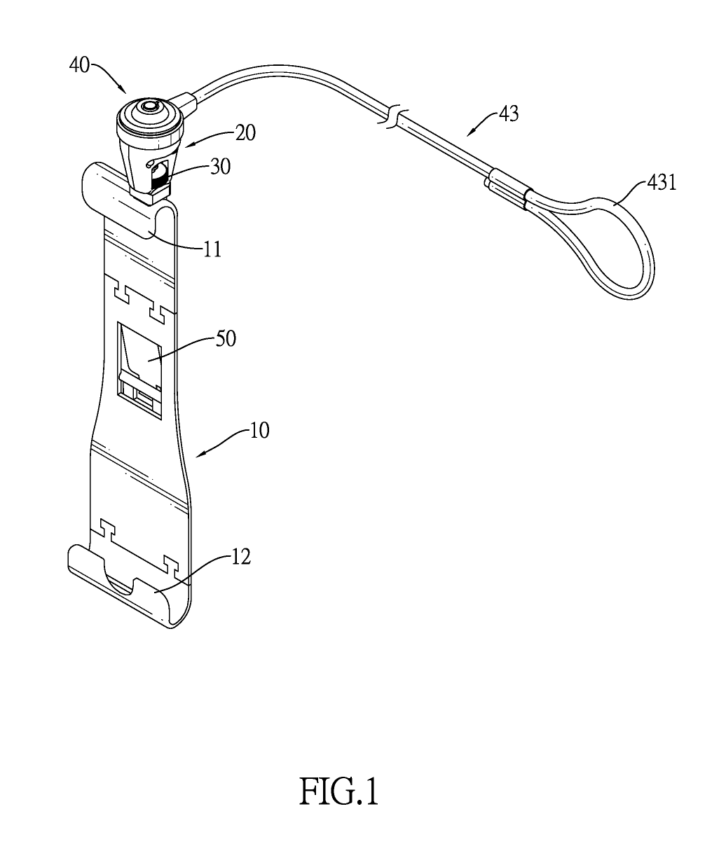

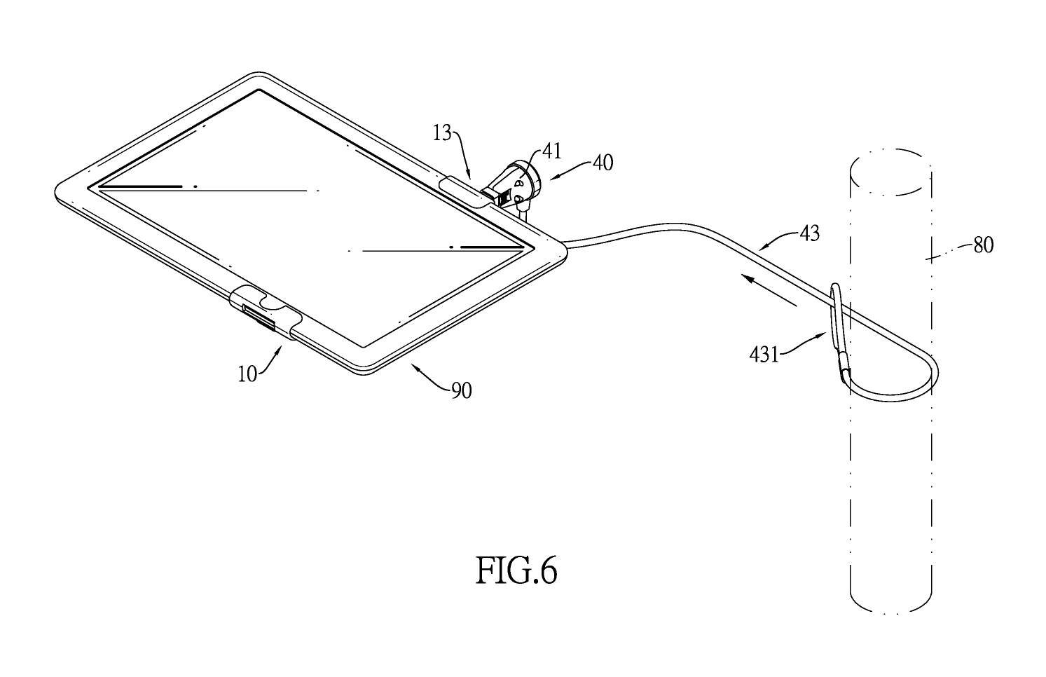

With reference to FIGS. 1 and 6, a first embodiment of a locking apparatus for a portable electron device 90 in accordance with the present invention has a main frame 10, a casing 20, an inserting element 30 and a lock 40.

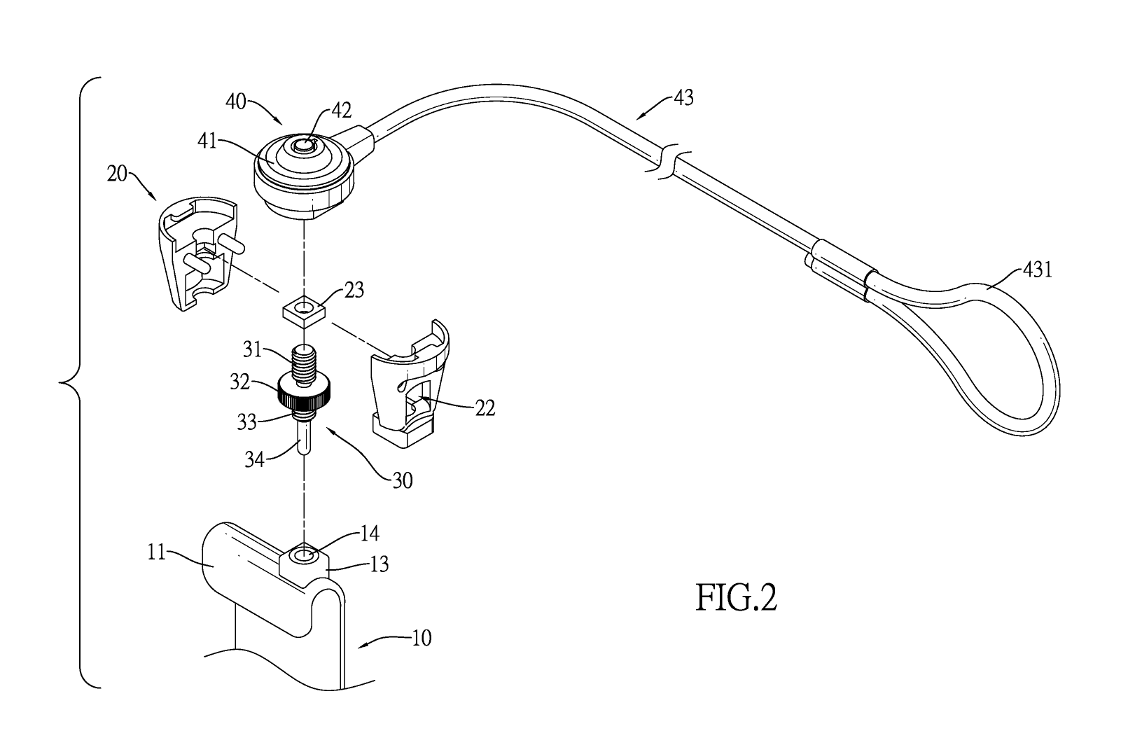

With further reference to FIGS. 1 and 2, the main frame 10 may be rectangular, may be composed of three elements with an ultrasonic welding process or may be formed by a single piece. The main frame 10 has a top end, a bottom end, a first clamping segment 11, a second clamping segment 12, a mounting segment 13, a limiting hole 14, an elongated hole and a supporting board 50.

The first clamping segment 11 is curvedly formed on the top end of the main frame 10 and has an opening and a top side. The second clamping segment 12 is curvedly formed on the bottom end of the main frame 10 and has an opening facing the opening of the first clamping segment 11. Then, the portable electron device 90 can be mounted in the main frame 10 by inserting the portable electron device 90 between the clamping segments 11, 12 as shown in FIG. 6. Because the clamping segments 11, 12 of the main frame 10 respectively abut against the top side and the bottom side of the portable electron device 90, the portable electron device 90 can be moved transversally relative to the main frame 10 between the clamping segments 11, 12.

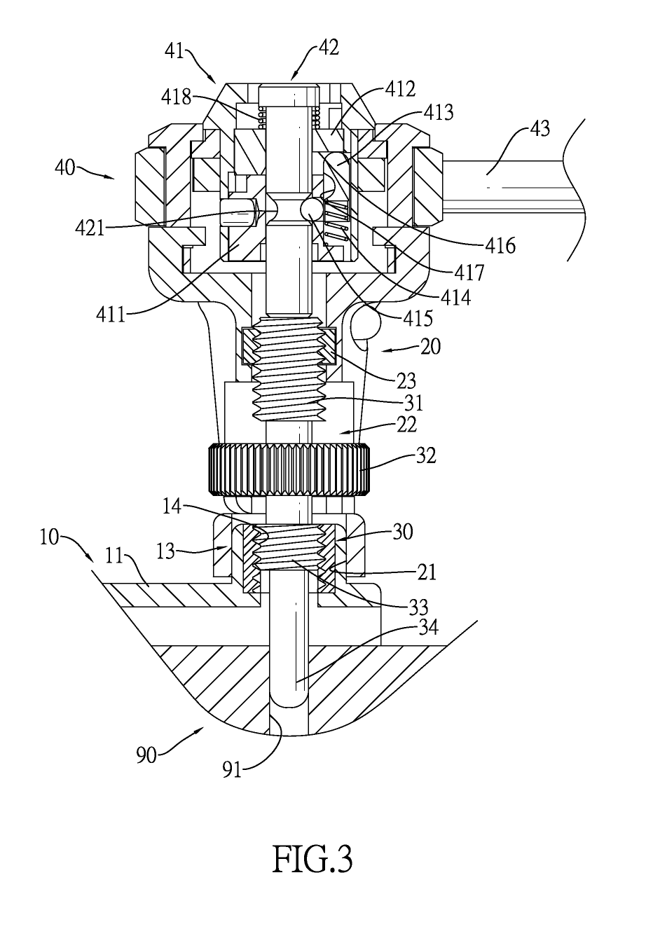

The mounting segment 13 may be square or non-circular and is formed on and protrudes from the top side of the first clamping segment 11. The limiting hole 14 is threaded and is formed through the mounting segment 13 and the first clamping segment 11 of the main frame 10. When the portable electron device 90 mounted in the main frame 10, an earphone hole 91 of the portable electron device 90 aligns with the limiting hole 14 of the main frame 10 as shown in FIG. 3.

The elongated hole is formed through the main frame 10 between the clamping segments 11, 12. The supporting board 50 is pivotally connected to the main frame 10 in the elongate hole. When an angle between the supporting board 50 and the main frame 10 is 180 degrees, the supporting board 50 is mounted in the elongate hole. When the angle between the supporting board 50 and the main frame 10 is smaller than 180 degrees, the supporting board 50 and the main frame 10 can provide a triangular structure with a tabletop, and this can hold the portable electron device 90 at a specific angle.

With further reference to FIGS. 2 and 3, the casing 20 may be composed of two half-casings, is mounted around the mounting segment 13 of the main frame 10 and has an lower end, an upper end, an external surface, a mounting opening 21, two operating openings 22 and a threaded panel 23. The mounting opening 21 is formed in the lower end of the casing 20 and is mounted around the mounting segment 13 of the main frame 10. The operating openings 22 are formed through the external surface of the casing 20 between the lower end and the upper end of the casing 20, align with each other and communicate with the mounting opening 21. The threaded panel 23 may be threaded and is mounted securely in the casing 20 between the half-casings above the mounting opening 21.

The inserting element 30 is mounted movably in the casing 20, is screwed with and mounted through the limiting hole 14 of the main frame 10 and is mounted into the earphone 91 of the portable electron device 90. The inserting element 30 has a top end, a bottom end, an external surface, an upper threaded segment 31, an operating segment 32, a lower threaded segment 33 and a shaft segment 34.

The top end of the inserting element 30 is mounted in the casing 20 below the upper end of the casing 20. The bottom end of the inserting element 30 extends out of the casing 20 via the mounting opening 21 and is mounted through the mounting segment 13 and the first clamping segment 11 of the main frame 10 via the limiting hole 14. The upper threaded segment 31 is formed around the external surface of the inserting element 30 at the top end of the inserting element 30 and is screwed with the threaded panel 23 of the casing 20.

The operating segment 32 may be circular, is formed around and protrudes from the external surface of the inserting element 30 below the upper threaded segment 31, partially extends out of the operating openings 22 of the casing 20 to enable a user to rotate the inserting element 30 relative to the casing 20 via the operating openings 22 and to enable the inserting element 30 to move upwardly or downwardly relative to the casing 20. The movement range of the inserting element 30 is limited by the operating segment 32 moving between the operating openings 22 of the casing 20 to prevent the inserting element 30 separating from the casing 20.

The lower threaded segment 33 is formed around the external surface of the inserting element 30 between the operating segment 32 and the bottom end of the inserting element 30 and is screwed with the limiting hole 14 of the main frame 10 via the mounting opening 21 of the casing 20 to connect the inserting element 30 and the casing 20 with the main frame 10. The shaft segment 34 is formed on and protrudes from the bottom end of the inserting element 30 below the lower threaded segment 33 and extends into the earphone hole 91 of the portable electron device 90 via the limiting hole 14 of the main frame 10.

As the above-mentioned statement, the portable electron device 90 only can be moved transversally relative to the main frame 10 by the clamping segments 11, 12. When the inserting element 30 is screwed with and mounted through the limiting hole 14 of the main frame 10 and is mounted in the earphone 91 of the portable electron device 90, the portable electron device 90 is securely connected to the main frame 10 without moving relative to and separating from the main frame 10.

The lock 40 may be a cylinder lock, is mounted securely in and extends out of the upper end of the casing 20 and has a body 41, a controlling element 42 and an extending element.

The body 41 is mounted securely in the upper end of the casing 20 and has a locking block 411, a rotating wheel 412, an engaging rod 413, a rod spring 414, a ball 415 and a returning spring 418. The locking block 411 is mounted in the body 41 and has a top side and multiple lower pins mounted on the top side of the locking block 411. The rotating wheel 412 is mounted rotatably on the locking block 411 and has a bottom side, multiple upper pins and an engaging recess 416. The upper pins are mounted on the bottom side of the rotating wheel 412 and respectively align with and abut the lower pins of the locking block 411. The engaging recess 416 is formed in the bottom side of the rotating wheel 412.

The engaging rod 413 is mounted movably and axially in the body 41 between the locking block 411 and the rotating wheel 412, selectively extends in the engaging recess 416 of the rotating wheel 412 and has a top, a bottom, an external surface and a ball recess 417. The top of the engaging rod 413 selectively extends into the engaging recess 416 of the rotating wheel 412. The ball recess 417 is formed in the external surface of the engaging rod 413 near the bottom of the engaging rod 413.

The rod spring 414 is mounted in the body 41 between the locking block 411 and the engaging rod 413 to push the engaging rod 413 to move upwardly relative to the locking block 411. The ball 415 selectively engages the engaging rod 413 in the ball recess 417 to compress the rod spring 414 by the engagement between the engaging rod 413 and the ball 415. The returning spring 418 is mounted in the body 41 and abuts against the rotating wheel 412.

The controlling element 42 is mounted movably in the body 41, aligns with and selectively abuts the inserting element 30 to limit the movement of the inserting element 30 and has a bottom end, a top end, an external surface and an annular recess 421. The bottom end of the controlling element 42 extends out of the body 41 and extends into the casing 20 to align with and to selectively abut the top end of the inserting element 30. The top end of the controlling element 42 selectively extends out of the body 41. The returning spring 418 is mounted between the top end of the controlling element 42 and the rotating wheel 412 of the body 41. The external surface of the controlling element 42 selectively abuts against the ball 415. The annular recess 421 is formed around the external surface of the controlling element 42 between the bottom end and the top end of the controlling element 42 and selectively engages the ball 415 to enable the ball 415 to hold between the ball recess 417 of the engaging rod 413 and the annular recess 421 of the controlling element 42.

The extending element may be a cord 43, is securely connected to the body 41 and has a connecting end, a mounting end and a ring segment 431. The connecting end of the cord 43 is securely connected to the body 41. The ring segment 431 is formed on the mounting end of the cord 43.

With further reference to FIGS. 3 and 6, when the lock 40 is set in a lock condition, the controlling element 42 is moved downwardly relative to the locking block 411 and the casing 20 to press the returning spring 418 and the annular recess 421 of the controlling element 42 engages with the ball 415. In addition, when the lock 40 is set in a lock condition, the rotating wheel 412 is rotated at a specified angle to enable the pins to move between the locking block 411 and the rotating wheel 412. Then, the rotating wheel 412 cannot be rotated relative to the locking block 411.

Furthermore, when a key is inserted into the locking block 411 to enable the lock 40 to set in a lock condition and to rotate the rotating wheel 412 to the specified angle, the engaging recess 416 of the rotating wheel 412 moves to over the engaging rod 413 and the engaging rod 413 engages the engaging recess 416 and the external surface of the engaging rod 413 engages the ball 415 by an elastic force of the rod spring 414. Then, the ball 415 is held between the annular recess 421 of the controlling element 42 and the external surface of the engaging rod 413 to prevent the controlling element 42 from moving axially relative to the locking block 411 and the casing 20. When the controlling element 42 is held in the body 41 by the ball 415, the bottom end of the controlling element 42 is moved close to or abuts with the top end of the inserting element 30. Then, the inserting element 30 cannot be moved upwardly relative to the casing 20, such that the shaft segment 34 of the inserting element 30 can be kept from being separated from the earphone hole 91 of the portable electron device 90. Consequently, the portable electron device 90 can be securely mounted in the main frame 10 without moving by the casing 20, the inserting element 30 and the lock 40.

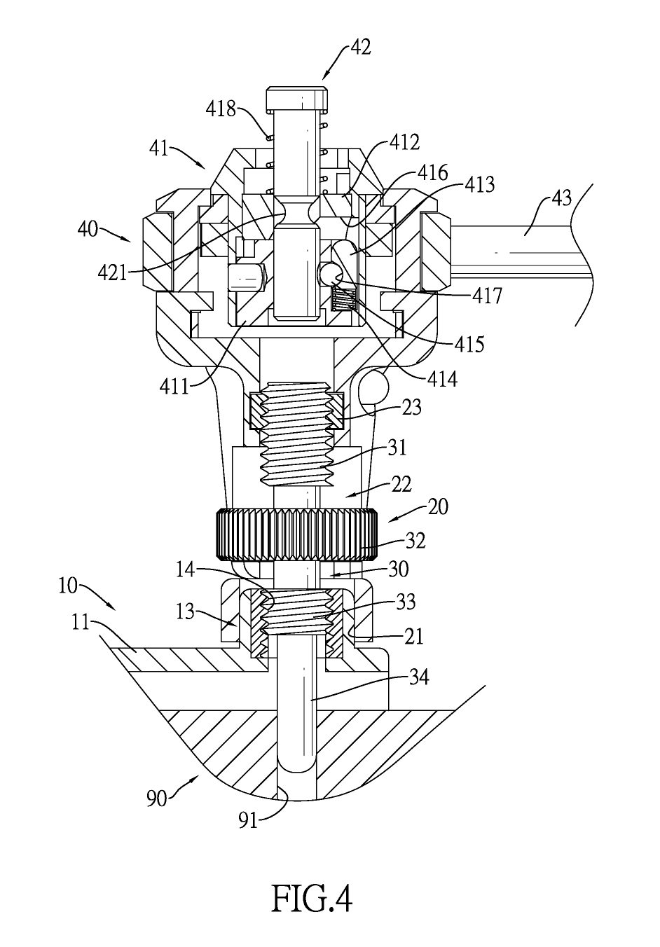

With reference to FIG. 4, when the key is inserted into the locking block 411 to push the pins to move out of an interface between the rotating wheel 412 and the locking block 411. Then, the rotating wheel 412 can be rotated relative to the locking block 411 by turning the key. When the rotating wheel 412 is rotated with the key, the engaging recess 416 will move and disengage from the engaging rod 413 and the rotating wheel 412 will push the engaging rod 413 to move downwardly to compress the rod spring 414. When the engaging rod 413 is moved downwardly relative to the locking block 411, the ball recess 417 will move to engage the ball 415 and to enable the ball 415 to disengage from the annular recess 421 of the controlling element 42. Because the ball 415 disengages from the annular recess 421 of the controlling element 42, the controlling element 42 can be moved upwardly relative to the body 41 of the lock 40 and the casing 20 by a compressed elastic force of the returning spring 418 as shown in FIG. 4.

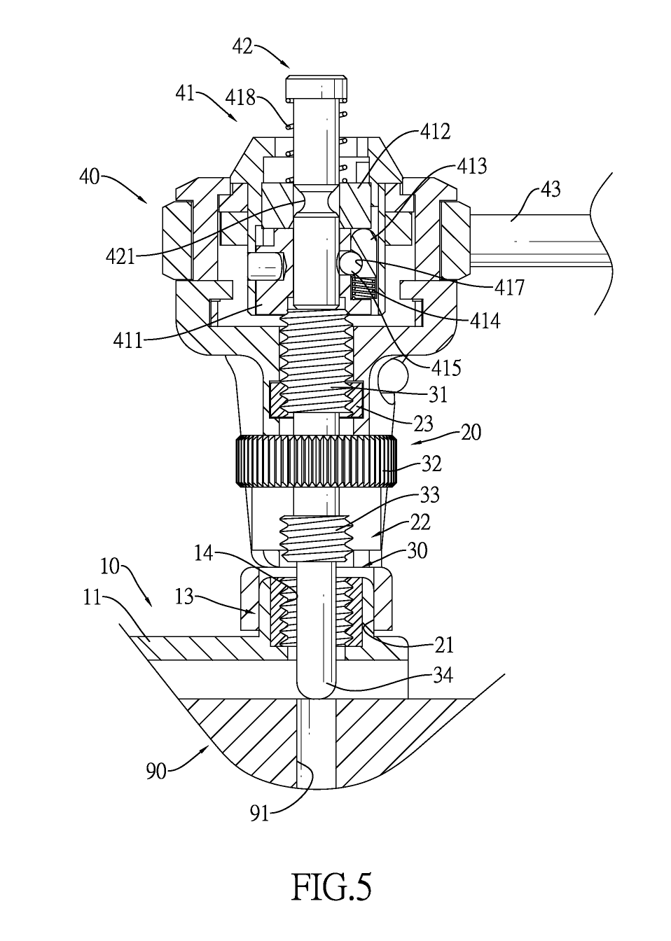

Furthermore, with reference to FIG. 5, when the controlling element 42 is moved upwardly relative to the casing 20, the inserting element 30 can be moved upwardly relative to the casing 20 and the main frame 10 by rotating the operating segment 32 via the operating openings 22 of the casing 20. Then, the lower threaded segment 33 can be disengaged from the limiting hole 14 of the main frame 10 and the shaft segment 34 of the inserting element 30 can be separated from the earphone hole 91 of the portable electron device 90. When the casing 20 and the inserting element 30 are removed from the main frame 10 and the portable electron device 90, the portable electron device 90 can be moved transversally relative to the main frame 10 between the clamping segments 11, 12 or can be separated from the main frame 10.

With reference to FIGS. 2 to 4, the lock 40 is set in a lock condition or an un-lock condition by rotating the rotating wheel 412 relative to the locking block 411. With further reference to FIG. 6, when a user wants to fix the portable electron device 90 with a post 80 that is securely mounted on a wall, first the portable electron device 90 is mounted in the main frame 10 between the clamping segments 11, 12. Then, the cord 43 of the lock 40 is surrounded the post 80, and the body 31 of the lock 30 and the casing 20 are mounted through the ring segment 431 of the cord 43 to enable the cord 43 to mount around the post 80. Later the mounting opening 21 of the casing 20 is mounted around the mounting segment 13 and the inserting element 30 is rotated to move downwardly relative to the casing 20 by rotating the operating segment 32 via the operating openings 22. Then, the shaft segment 34 of the inserting element 30 is mounted in the earphone hole 91 of the portable electron device 90 via the limiting hole 14 of the mounting segment 13 and the lower threaded segment 33 is screwed with the limiting hole 14 of the mounting segment 13.

At this time, the controlling element 42 can be pressed to move downwardly relative to the body 41 of the lock 40 to enable the ball 415 to disengage from the ball recess 417 and to move to engage the annular recess 421 of the controlling element 42 to prevent the controlling element 42 from moving relative to the body 41 of the lock 40. Furthermore, the bottom end of the controlling element 42 is moved close to or abuts with the top end of the inserting element 30 to prevent the shaft segment 34 of the inserting element 30 separating from the earphone hole 91 of the portable electron device 90. Additionally, the portable electron device 90 is securely mounted in the main frame 10 by the inserting element 30, the casing 20 and the lock 40, is fixed securely with a post 80 that is securely mounted on a wall and this can prevent the portable electron device 90 from being stolen when the portable electron device 90 is not taken with the user.

When the user wants to separate the portable electron device 90 from the main frame 10, the key is inserted into the lock 40 to rotate the rotating wheel 412 to rotate relative to the locking body 411, the engaging rod 413 is pushed downwardly by the rotating wheel 412 to press the rod spring 414 to enable the ball to disengage from the annular recess 421 of the controlling element 42 and to engage the ball recess 417 of the engaging rod 413. Then, the controlling element 42 can be moved upwardly relative to the body 41 of the lock 40 by the returning spring 418, and the inserting element 30 can be rotated to move upwardly relative to the casing 20 and the main frame 10. Consequently, the shaft segment 34 can be remove from the earphone hole 91 of the portable electron device 90, and the portable electron device 90 can be moved transversally relative to the clamping segments 11, 12 of the main frame 10 and also can be separated from the main frame 10.

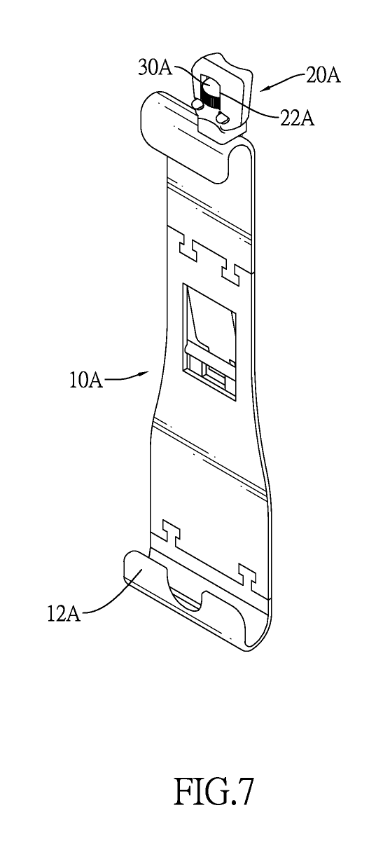

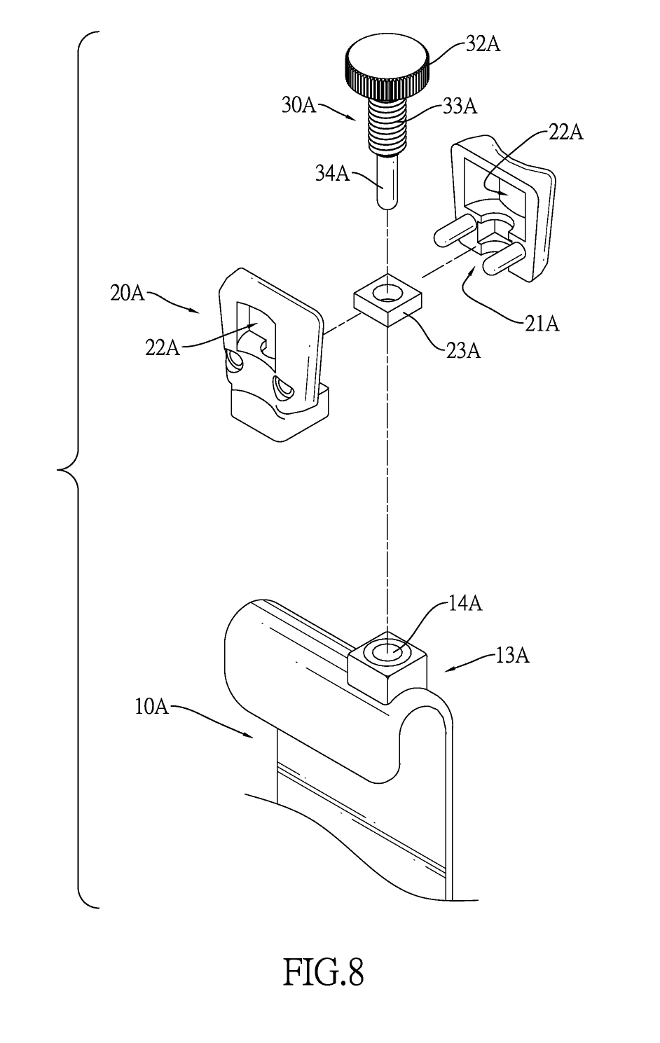

With reference to FIGS. 7 to 10, the second embodiment of a locking apparatus for a portable electron device in accordance with the present invention has a structure substantially same as that in the first embodiment except that the locking apparatus does not has a lock, the inserting element 30A does not has an upper threaded segment and the lower threaded segment 33A is screwed with the threaded panel 23A and the limiting hole 14A of the main frame 10A and the cord 70A has a first ring segment 71A and a second ring segment 72A respectively formed on the mounting end and the connecting end of the cord 70A.

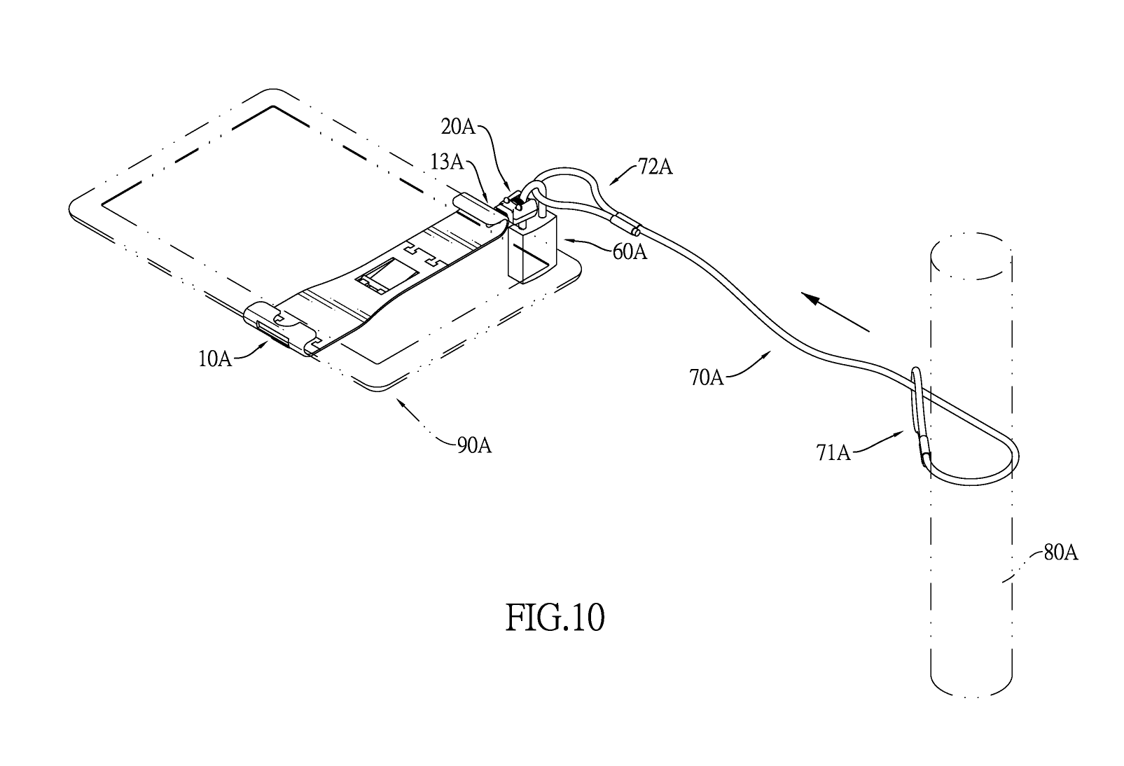

With reference to FIG. 10, when a user wants to fix a portable electron device 90A with a post 80A that is securely mounted on a wall, first the portable electron device 90A is mounted in the main frame 10A between the clamping segments 11A, 12A. Then, the cord 70A is surrounded the post 80A, and the casing 20A and the inserting element 30A are mounted through the first ring segment 71A of the cord 70A to enable the cord 70A to mount around the post 80A. Later the mounting opening 21A of the casing 20A is mounted around the mounting segment 13A and the inserting element 30A is rotated to move downwardly relative to the casing 20A by rotating the operating segment 32A via the operating openings 22A. Then, the shaft segment 34A of the inserting element 30A is mounted in an earphone hole 91A of the portable electron device 90A via the limiting hole 14A of the mounting segment 13A and the lower threaded segment 33A is screwed with the threaded panel 23A of the casing 20A and the limiting hole 14A of the mounting segment 13A.

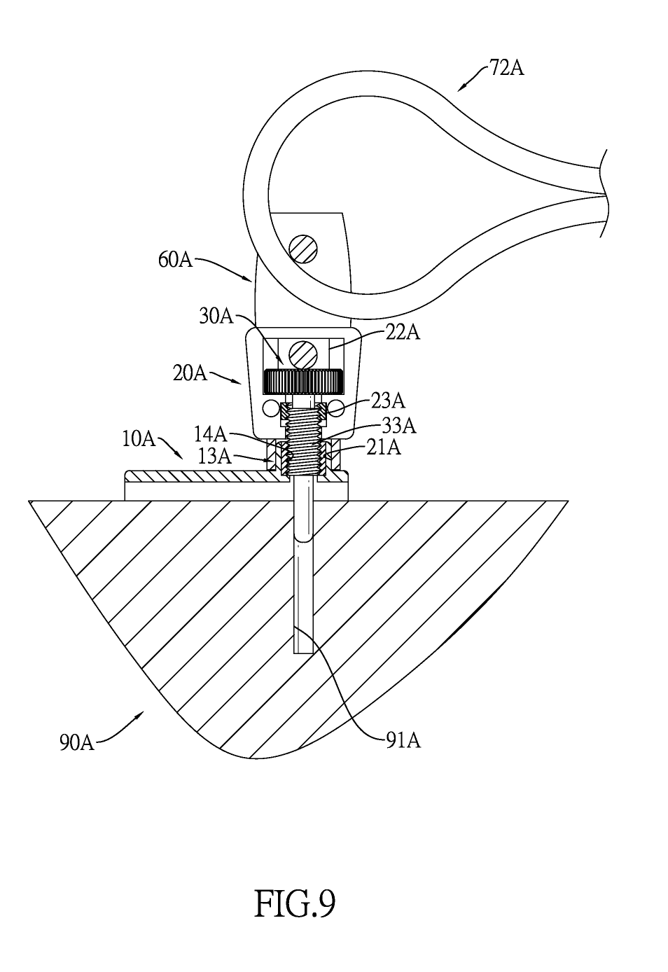

At this time, a padlock 60A is mounted through the operating openings 22A of the casing 20A and the second ring segment 72A of the cord 70A to prevent the inserting element 30A from moving upwardly relative to the casing 20A and the main frame 10A as shown in FIG. 9. Then, the portable electron device 90A is securely mounted in the main frame 10A by the inserting element 30A, the casing 20A, the cord 70A and the padlock 60A and this can prevent the portable electron device 90A from being stolen when the portable electron device 90A is not taken with the user.

When the user wants to separate the portable electron device 90A from the main frame 10A, a key is inserted into the padlock 60A to unlock the padlock 60A to separate from the second ring segment 72A and the operating openings 22A of the casing 20A. Then, the inserting element 30A can be moved upwardly relative to the casing 20A and the main frame 10A. Consequently, the shaft segment 34A of the inserting element 30A can be remove from the earphone hole 91A of the portable electron device 90A, and the portable electron device 90A can be moved transversally relative to the clamping segments 11A, 12A of the main frame 10A and also can be separated from the main frame 10A.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A locking apparatus for a portable electron device, having:
a main frame having:
a top end;
a bottom end;
a first clamping segment curvedly formed on the top end of the main frame and having an opening and a top side;
a second clamping segment curvedly formed on the bottom end of the main frame and having an opening facing the opening of the first clamping segment;
a mounting segment formed on and protruding from the top side of the first clamping segment; and
a limiting hole being threaded and formed through the mounting segment and the first clamping segment of the main frame;
a casing mounted around the mounting segment of the main frame and having:
a lower end;
an upper end;
an external surface;
a mounting opening formed in the lower end of the casing and mounted around the mounting segment of the main frame; and
at least one operating opening formed through the external surface of the casing between the lower end and the upper end of the casing and communicating with the mounting opening;
an inserting element mounted movably in the casing, screwed with and mounted through the limiting hole of the main frame and having:
a top end mounted in the casing below the upper end of the casing;
a bottom end extending out of the casing via the mounting opening and mounted through the mounting segment and the first clamping segment of the main frame via the limiting hole; and
an external surface partially extends out of the at least one operating opening of the casing;
a lock mounted securely in and extending out of the upper end of the casing and having:
a body mounted securely in the upper end of the casing;
a controlling element mounted movably in the body, aligning with and selectively abutting the inserting element to limit the movement of the inserting element; and
an extending element securely connected to the body and having:
a connecting end securely connected to the body; and
a mounting end.

2. The locking apparatus as claimed in claim 1, wherein the mounting segment is non-circular and the mounting opening of the casing is mounted around the mounting segment of the main frame.

3. The locking apparatus as claimed in claim 1, wherein
the casing has a threaded panel mounted securely in the casing above the mounting opening; and
the inserting element is screwed with the threaded panel of the casing and the limiting hole of the main frame.

4. The locking apparatus as claimed in claim 2, wherein
the casing has a threaded panel mounted securely in the casing above the mounting opening; and
the inserting element is screwed with the threaded panel of the casing and the limiting hole of the main frame.

5. The locking apparatus as claimed in claim 1, wherein the extending element of the lock is a cord.

6. The locking apparatus as claimed in claim 2, wherein the extending element of the lock is a cord.

7. The locking apparatus as claimed in claim 5, wherein the extending element of the lock has a ring segment formed on the mounting end of the extending element.

8. The locking apparatus as claimed in claim 6, wherein the extending element of the lock has a ring segment formed on the mounting end of the extending element.

9. The locking apparatus as claimed in claim 1, wherein the lock is a cylinder lock.

10. The locking apparatus as claimed in claim 2, wherein the lock is a cylinder lock.

11. The locking apparatus as claimed in claim 7, wherein the lock is a cylinder lock.

12. The locking apparatus as claimed in claim 8, wherein the lock is a cylinder lock.

13. A locking apparatus for a portable electron device, having:
a main frame having:
a top end;
a bottom end;
a first clamping segment curvedly formed on the top end of the main frame and having an opening and a top side;
a second clamping segment curvedly formed on the bottom end of the main frame and having an opening facing the opening of the first clamping segment;
a mounting segment formed on and protruding from the top side of the first clamping segment; and
a limiting hole being threaded and formed through the mounting segment and the first clamping segment of the main frame;
a casing mounted around the mounting segment of the main frame and having:
a lower end;
an upper end;
an external surface;
a mounting opening formed in the lower end of the casing and mounted around the mounting segment of the main frame; and
two operating openings formed through the external surface of the casing between the lower end and the upper end of the casing, aligning with each other and communicating with the mounting opening; and
an inserting element mounted movably in the casing, screwed with and mounted through the limiting hole of the main frame and having:
a top end mounted in the casing below the upper end of the casing;
a bottom end extending out of the casing via the mounting opening and mounted through the mounting segment and the first clamping segment of the main frame via the limiting hole; and
an external surface partially extends out of the operating openings of the casing.

14. The locking apparatus as claimed in claim 13, wherein the mounting segment is non-circular and the mounting opening of the casing is mounted around the mounting segment of the main frame.

15. The locking apparatus as claimed in claim 13, wherein
the casing has a threaded panel mounted securely in the casing above the mounting opening; and
the inserting element is screwed with the threaded panel of the casing and the limiting hole of the main frame.

16. The locking apparatus as claimed in claim 14, wherein
the casing has a threaded panel mounted securely in the casing above the mounting opening; and
the inserting element is screwed with the threaded panel of the casing and the limiting hole of the main frame.
